(19) United States
(12) Patent Application Publication
(10) Pub. No.: US 2010/0247074 A1
(43) Pub. Date: Sep. 30, 2010

(54) REPRODUCING DEVICE AND STORAGE MEDIUM

(75) Inventor: Takuji Kimura, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/748,330

(22) Filed: Mar. 26, 2010

(30) Foreign Application Priority Data
Mar. 31, 2009 (JP) 2009-088018

(51) Int. Cl. H04N 5/91

(52) U.S. Cl. 386/94; 386/E05.003

(57) ABSTRACT

A reproducing device includes: a reading module configured to read at least any of content data, a content reproduction permitting condition and a reproducing device reproduction permitting condition from a storage medium detachable to/from the reproducing device; a reproducing module configured to reproduce the content data; a content determining module configured to determine whether the content reproduction permitting condition is satisfied or not; a reproducing device determining module configured to determine whether the reproducing device reproduction permitting condition is satisfied or not; and a reproduction controller configured to control the reproducing module to reproduce the content data when the content reproduction permitting condition for the content data is determined to be reproducible by the content determining module and the reproducing device reproduction permitting condition for the reproducing device is determined to be reproducible by the reproducing device determining module.

### CROSS-REFERENCE TO RELATED APPLICATIONS

This application is based upon and claims the benefit of priority from Japanese Patent Application No. 2009-088018, filed on Mar. 31, 2009, the entire contents of which are incorporated herein by reference.

### BACKGROUND

1. Field

An aspect of the present invention relates to a reproducing device and a storage medium that stores content to be reproduced by the reproducing device.

2. Description of the Related Art

In recent years, distribution of digital content has spread through Internet or media. For this reason, it is urgently necessary to copyright the content. JP-A-2008-153583 discloses an example of a method of copyrighting content. According to the technique, a media storing a remake content created based on a certain original content is accompanied by copyright information about the original content and the remake content.

The copyright information about the original content indicates a writer of the original content and a date and time of creation. The copyright information about the remake content indicates a creator and a creating date and time of the remake content, an identification code of an apparatus used for the creation, reproduction permitting information for a reproducing device, and so on. By the accompaniment of the copyright information, it is possible to restrict a right for private use of the content.

In place of a rental service of a DVD or a CD, a paid delivering service of content utilizing a storage medium has also spread. Referring to the paid delivering service of the content, a user down leads content such as a video or music from a delivering terminal into rewritable media, such as an SD memory card, which is prepared for copyrighting, and utilizes the content at home. As compared with a related rental service, a spread of the utilization can be expected more greatly because of convenience that a troublesome work of returning the media is not required.

In using the content delivering service, a reproducing device possessed by a user does not always have a reproducing function corresponding to the content even if a storage medium can be attached/removed. On the other hand, when a reproducing device having a reproducing function corresponding to the content is rent out, a troublesome work is required for returning the reproducing device. For this reason, the convenience of the service is damaged.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary general view showing a content delivering system according to an embodiment of the invention.

FIG. 2 is an exemplary functional block diagram showing a reproducing device according to the embodiment of the invention.

FIG. 3 is a diagram showing an example of a storing state of an SD memory card according to the embodiment of the invention.

FIG. 4 is an exemplary diagram showing items of Content Usage Rule information to be stored in the SD memory card according to the embodiment.

FIG. 5 is an exemplary diagram showing a relationship between a reproduction enabling period and a reproducing valid period according to the embodiment.

FIG. 6 is an exemplary diagram showing items of Device Usage Rule information to be stored in the SD memory card according to the embodiment.

FIG. 7 is an exemplary flowchart showing a reproducing determination through the Device Usage Rule information of the reproducing device according to the embodiment of the invention.

FIG. 8 is an exemplary flowchart showing processing for setting the Device Usage Rule information of the reproducing device according to the embodiment of the invention.

FIG. 9 is an exemplary flowchart showing processing to be carried out in an initial reproduction through the Device Usage Rule information of the reproducing device according to the embodiment of the invention.

FIG. 10 is an exemplary flowchart showing a reproducing determination through the Content Usage Rule information of the reproducing device according to the embodiment of the invention.

FIG. 11 is an exemplary flowchart showing processing for setting the Content Usage Rule information of the reproducing device according to the embodiment of the invention.

FIG. 12 is an exemplary flowchart showing processing to be carried out in an initial reproduction through the Content Usage Rule information of the reproducing device according to the embodiment of the invention.

### DETAILED DESCRIPTION

Various embodiments according to the present invention will be described hereinafter with reference to the accompanying drawings. In general, according to one embodiment of the present invention, there is provided a reproducing device including: a reading module configured to read at least any of content data, a content reproduction permitting condition and a reproducing device reproduction permitting condition from a storage medium detachable to/from the reproducing device; a reproducing module configured to reproduce the content data; a content determining module configured to determine whether the content reproduction permitting condition is satisfied or not; a reproducing device determining module configured to determine whether the reproducing device reproduction permitting condition is satisfied or not; and a reproduction controller configured to control the reproducing module to reproduce the content data when the content reproduction permitting condition for the content data is determined to be reproducible by the content determining module and the reproducing device reproduction permitting condition for the reproducing device is determined to be reproducible by the reproducing device determining module.

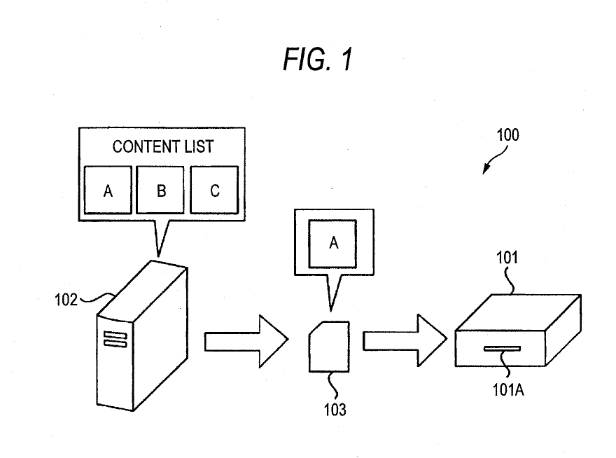

An embodiment according to the invention will be described below with reference to FIGS. 1 to 12. FIG. 1 is a general view showing a content delivering system 100 according to the embodiment of the invention. The content delivering system 100 is configured by a reproducing device 101, a content delivering terminal 102 and a Security Digital (SD) memory card 103.

The reproducing device 101 serves to reproduce content stored in a storage medium. The SD memory card 103 can be attached/removed to/from the reproducing device 101 according to the embodiment, and the reproducing device 101 can reproduce the content stored in the SD memory card 103. The reproducing device 101 may be a television receiver or a personal computer, for example.

The content delivering terminal 102 is a storefront terminal for selling content delivered from an external server to a user. The content delivering terminal 102 displays the delivered content in a list to the user and charges the user with a cost of the selected content when he (or she) purchases the content.

The SD memory card 103 is a storage medium for storing content down led from the content delivering terminal 102 or other devices. The SD memory card 103 is compatible with Content Protection for Recordable Media (CPRM).

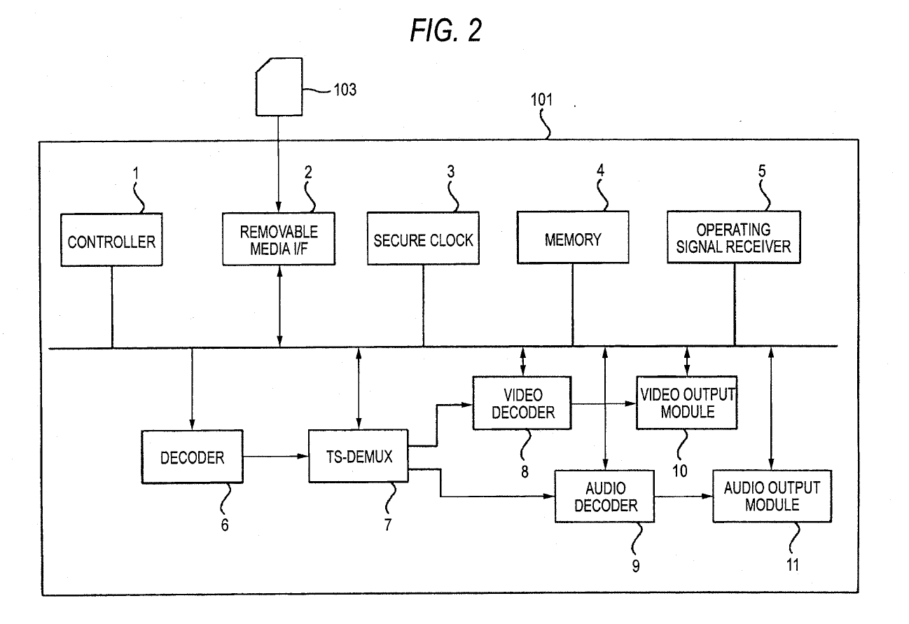

Next, a function of the reproducing device 101 according to the embodiment will be described with reference to FIG. 2. FIG. 2 is a functional block diagram showing the reproducing device 101 according to the embodiment.

The reproducing device 101 is configured by a controller 1, a removable media I/F 2, a secure clock 3, a memory 4, an operating signal receiver 5, a decoder 6, a Transport Stream-demultiplexer (TS-DEMUX) 7, a video decoder 8, an audio decoder 9, a video output module 10, and an audio output module 11.

The controller 1 executes a command by a control program for implementing each function and controls a whole operation of the reproducing device 101.

The removable media I/F 2 reads information stored in a storage medium such as the SD memory card 103.

The secure clock 3 is a secure clock by which a user cannot improperly update a value. For example, current time information is always or periodically acquired from a reliable time server through Internet.

The memory 4 stores content read from the removable media I/F 2 and content delivered from a broadcasting station.

The operating signal receiver 5 receives an operating signal from an operating module such as a button provided in the reproducing device 101 or a remote controller (not shown) capable of carrying out a wireless communication through an infrared-ray communication, and transmits the operating signal to the controller 1.

The decoder 6 reads a content file 214 and Content Usage Rule information 216 which are stored in the SD memory card 103 and decodes the content by using key information stored in Content Usage Rule information 216B. The decoder 6 transmits the decoded content to the TS-DEMUX 7.

The TS-DEMUX 7 demultiplexes the decoded content transmitted from the decoder 6 into video data and audio data. The TS-DEMUX 7 transmits the video data and the audio data thus obtained by the demultiplex to the video decoder 8 and the audio decoder 9, respectively.

The video decoder 8 carries out a decode processing over the video data transmitted from the TS-DEMUX 7 in accordance with a given format.

The audio decoder 9 carries out the decode processing over the audio data transmitted from the TS-DEMUX 7 in accordance with a given format.

The video output module 10 reproduces the video data subjected to the decode processing by the video decoder 8 and outputs the reproduced video data to a screen provided in the reproducing device 101.

The audio output module 11 reproduces the audio data subjected to the decode processing by the audio decoder 9 and outputs the reproduced audio data to a speaker provided in the reproducing device 101.

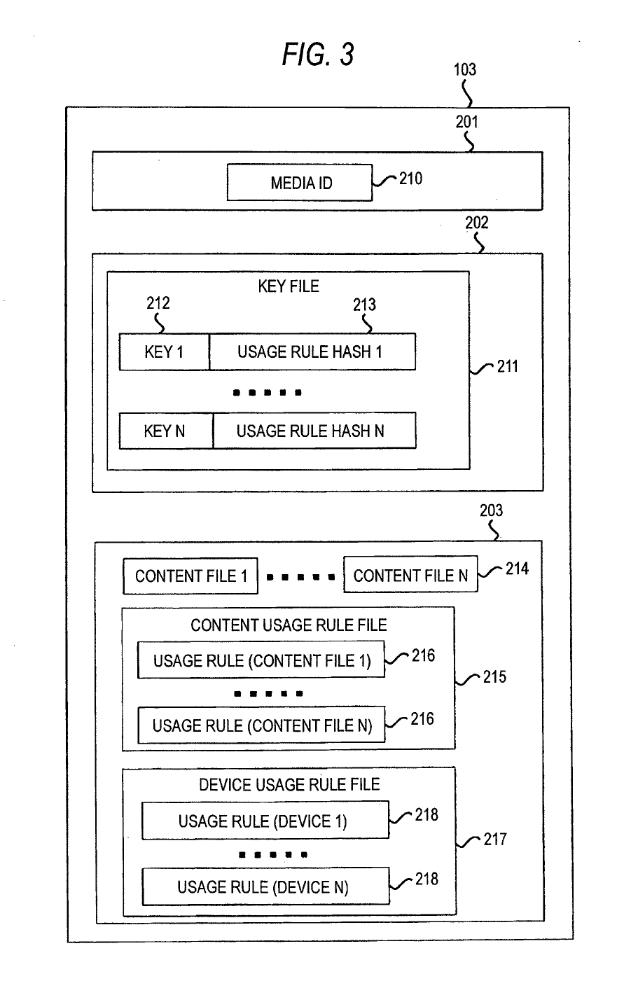

Next, description will be given to a storing state of the SD memory card 103. FIG. 3 shows an example of a storing state of the SD memory card 103 according to the embodiment of the invention.

The SD memory card 103 has a system region 201, an authenticating region 202 and a normal region 203.

The system region 201 stores a media ID 210. The media ID 210 is a unique identifier to the SD memory card 103.

The authenticating region 202 stores a key file 211. The key file 211 stores content encryption key information 212 and a hash value 213.

The content encryption key information 212 is key information of the content file 214 stored in the normal region 203. The hash value 213 serves to detect tampering of the Content Usage Rule information 216. Although the single key file 211 stores plural pieces of content encryption key information 212 and hash values 213 in the embodiment, a file may be divided every content.

The normal region 203 stores plural content files 214, a Contents Usage Rule File 215, and a Devices Usage Rule File 217.

The content file 214 is downloaded into the SD memory card 103 from the content delivering terminal 102 and is copyrighted. The content file includes a rental content having a content reproduction permitting condition and a purchase content which does not have the reproduction permitting condition but can be possessed by a user. The rental content also stores the Content Usage Rule information 216 for giving the reproduction permitting condition to the content together.

The Contents Usage Rule File 215 is a file which stores Usage Rule related to each content file 214. More specifically, the Contents Usage Rule File 215 stores plural pieces of Content Usage Rule information 216. The Content Usage Rule information 216 stores Usage Rule related to the content file 214. Items stored in the Content Usage Rule information 216 will be described below. Although the plural pieces of Content Usage Rule information 216 are stored in a single file in the embodiment, the file may be divided every content file 214. Although the Contents Usage Rule File 215 is stored in the normal region 203 in the embodiment, moreover, it may be stored in the authenticating region 202. Furthermore, the Contents Usage Rule File 215 and the content encryption key information 212 may be merged and disposed in the authenticating region 202. In the case in which the Contents Usage Rule File 215 is stored in the authenticating region 202, it is hard to tamper the Content Usage Rule information 216. Therefore, the hash value 213 is not always required.

The Devices Usage Rule File 217 is a file which stores Usage Rule related to each reproducing device 101. In other words, the Devices Usage Rule File 217 stores plural pieces of Device Usage Rule information 218. The Device Usage Rule information 218 is previously encrypted with unique key data to the media ID 210 and the reproducing device 101 and is thus stored. Items stored in the Device Usage Rule information 218 will be described below. Although the plural pieces of Device Usage Rule information 218 are stored in a single file in the embodiment, the file may be divided every reproducing device 101.

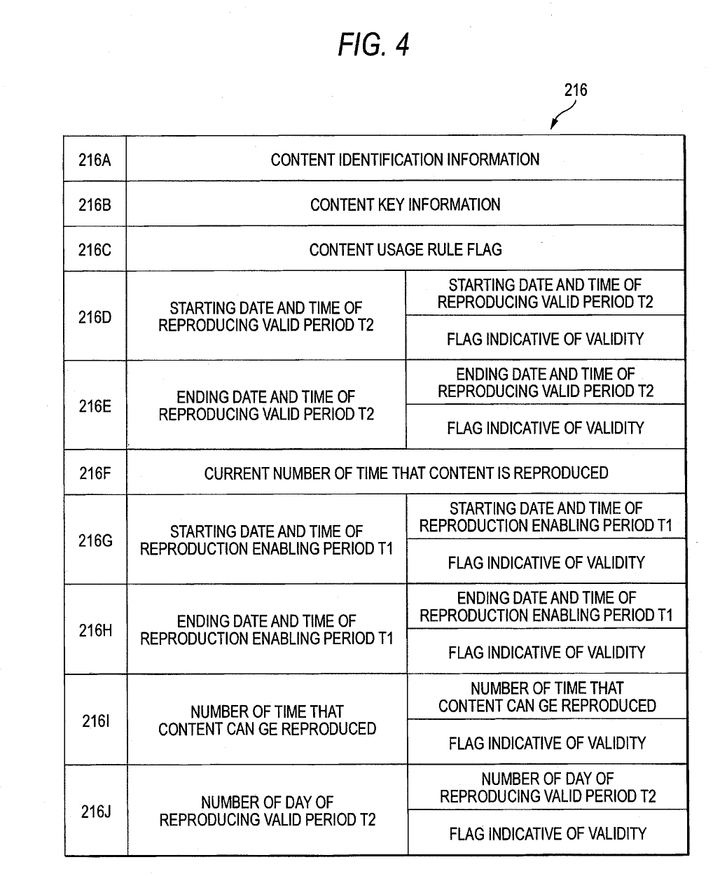

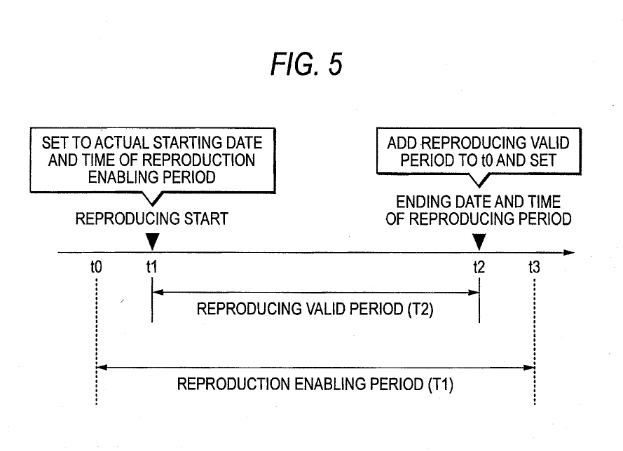

Next, the items stored in the Content Usage Rule information 216 will be described with reference to FIGS. 4 and 5. FIG. 4 is a diagram showing the item of the Content Usage Rule information 216 stored in the SD memory card 103 according to the embodiment. FIG. 5 is a diagram showing a relationship between a reproduction enabling period T1 and a reproducing valid period T2 according to the embodiment.

The Content Usage Rule information 216 stores content identification information 216A, the content key information 216B, a content Usage Rule flag 216C, a starting date and time 216D of a reproducing valid period T2, an ending date and time 216E of the reproducing valid period T2, a current number of times 216F that the content is reproduced, a starting date and time 216G of the reproduction enabling period T1, an ending date and time 216H of the reproduction enabling period T1, the number of times 216I that the content can be reproduced, and the number of days 216J of the reproducing valid period T2.

The content identification information 216A is a unique identifier to content.

The content key information 216B is related to a key used for encrypting the content file 214.

The content Usage Rule flag 216C indicates whether the item stored in the Content Usage Rule information 216 is valid or not.

The starting date and time 216D of the reproducing valid period T2 stores the starting date and time of the reproducing valid period T2 and the flag indicative of a validity thereof. The starting date and time of the reproducing valid period T2 is a time that a reproduction is started, and corresponds to a time of t1 in FIG. 5.

The ending date and time 216E of the reproducing valid period T2 stores an ending date and time of the reproducing valid period T2 which is counted from the starting date and time 216D of the reproducing valid period T2, and a flag indicative of a validity thereof. The ending date and time 216E of the reproducing valid period T2 indicates a date and time which is obtained by adding the number of days 216J of the reproducing valid period T2 to the starting date and time 216D of the reproducing valid period T2. In the example of FIG. 5, a time of t2 obtained by adding the number of days 216J of the reproducing valid period T2 to the time of t1 corresponds to the ending date and time of the reproducing valid period T2.

The current number of times 216F that the content is reproduced indicates the number of times that the content file 214 is reproduced. The case in which the content is reproduced from beginning to last may be counted as one time or the case in which the content is reproduced continuously for a threshold time or more may be counted as one time.

The starting date and time 216G of the reproduction enabling period T1 stores a starting date and time of a period for which the content file 214 can be reproduced, and a flag indicative of a validity thereof. The starting date and time of the period for which the content file 214 can be reproduced is set when the content file 214 is downloaded from the content delivering terminal 102 into the SD memory card 103. In FIG. 5, the starting date and time of the reproduction enabling period corresponds to t0. In the case in which the reproduction is not executed, the starting date and time t0 of the reproduction enabling period T1 and the starting date and time t1 of the reproducing valid period T2 are set to be identical to each other.

The ending date and time 216H of the reproduction enabling period T1 stores an ending date and time of the reproduction enabling period T1 of the content file 214, and a flag indicative of a validity thereof. The ending date and time of the reproduction enabling period T1 of the content file 214 is set when the content file 214 is downloaded from the content delivering terminal 102 into the SD memory card 103. In FIG. 5, the ending date and time of the reproduction enabling period T1 corresponds to t3. The reproduction enabling period T1 determined by the starting date and time of the reproduction enabling period T1 and the ending date and time of the reproduction enabling period T1 is longer than the reproducing valid period T2. By setting the reproducing valid period T2 within the reproduction enabling period T1, wider choices of the period for which a user carries out a reproduction is offered.

The content reproduction enabling number 216I stores the number of times that the content file 214 can be reproduced, and a flag indicative of a validity thereof. The number of times that the content file 214 can be reproduced is set when the content file 214 is downloaded from the content delivering terminal 102 into the SD memory card 103, and it is assumed that accounting is carried out depending on the number of times, for example.

The number of days 216J of the reproducing valid period T2 stores the number of days of the reproducing valid period T2 which indicates a reproduction enabling period after the content file 214 is actually reproduced, and a flag indicative of a validity thereof. The number of days of the reproducing valid period T2 is set when the content file 214 is downloaded from the content delivering terminal 102 to the SD memory card 103, and it is assumed that accounting is carried out depending on the number of days of the reproducing valid period T2, for example. If the reproducing valid period T2 is exceeded, the content file 214 may be prevented from being reproduced according to user's setting or the content file 214 may be automatically erased from the normal region 203.

In the embodiment, in the case in which the Content Usage Rule information 216 is stored, a reproduction permitting condition is set to the content in the content delivering terminal 102. In other words, the content is reproduced only in the case in which the reproduction permitting condition is satisfied. On the other hand, the case in which the Content Usage Rule information 216 is not stored corresponds to the case in which the content is purchased, for example. In this case, the user can utilize the content irrespective of the Content Usage Rule information 216.

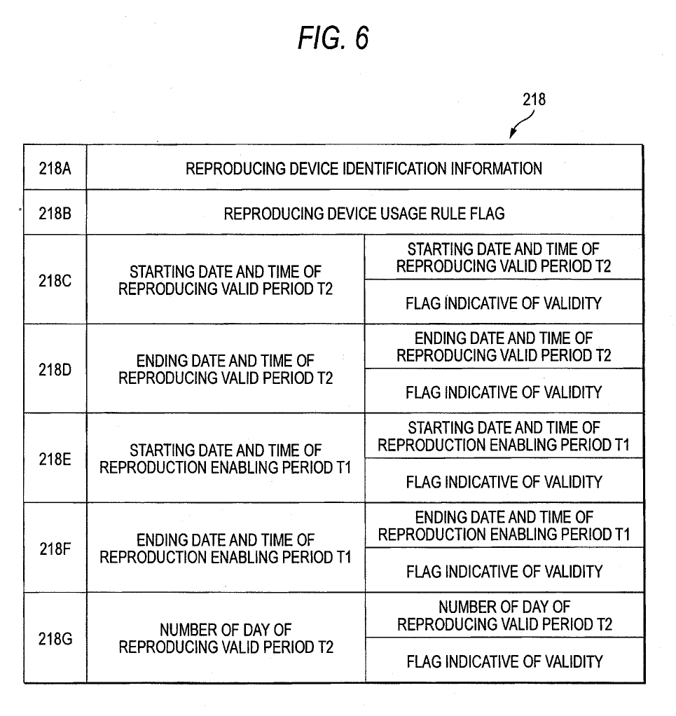

Next, the items to be stored in the Device Usage Rule information 218 will be described with reference to FIG. 6. FIG. 6 is a diagram showing the items of the Device Usage Rule information 218 to be stored in the SD memory card 103 according to the embodiment.

The Device Usage Rule information 218 stores reproducing device identification information 218A, a reproducing device Usage Rule flag 218B, a starting date and time 218C of a reproducing valid period T2, an ending date and time 218D of the reproducing valid period T2, a starting date and time 218E of a reproduction enabling period T1, an ending date and time 218F of the reproduction enabling period T1, and a number of days 218G of the reproducing valid period T2.

The reproducing device identification information 218A is a unique identifier to the reproducing device 101 and indicates a type and a model of the reproducing device, for example.

The reproducing device Usage Rule flag 218B indicates whether the item stored in the Device Usage Rule information 218 is valid or not.

The starting date and time 218C of the reproducing valid period T2 stores a starting date and time of the reproducing valid period T2, and a flag indicative of a validity thereof. Since the Device Usage Rule information 218C is similar to the Content Usage Rule information 216D, description will be omitted.

The ending date and time 218D of the reproducing valid period T2 stores an ending date and time of the reproducing valid period T2 which is counted from the starting date and time 218C of the reproducing valid period T2, and a flag indicative of a validity thereof. Since the Device Usage Rule information 218D is similar to the Content Usage Rule information 216E, description will be omitted.

The starting date and time 218E of the reproduction enabling period T1 stores a starting date and time of the reproduction enabling period T1 of the content file 214 in the reproducing device 101, and a flag indicative of a validity thereof. Since the Device Usage Rule information 218E is similar to the Content Usage Rule information 216G, description will be omitted.

The ending date and time 218F of the reproduction enabling period T1 stores an ending date and time of the reproduction enabling period T1 of the content file 214 in the reproducing device 101, and a flag indicative of a validity thereof. Since the Device Usage Rule information 218F is similar to the Content Usage Rule information 216H, description will be omitted.

The number of days 218G of the reproducing valid period T2 stores the number of days of the reproducing valid period T2 which indicates the number of days that a reproduction can be carried out after the content file 214 is actually reproduced in the reproducing device 101, and a flag indicative of a validity thereof. Since the Device Usage Rule information 218G is similar to the Content Usage Rule information 216J, description will be omitted.

The Device Usage Rule information 218 is stored so that reproduction permitting condition is set to the reproducing device 101 for reproducing the content file 214 in addition to the content file 214.

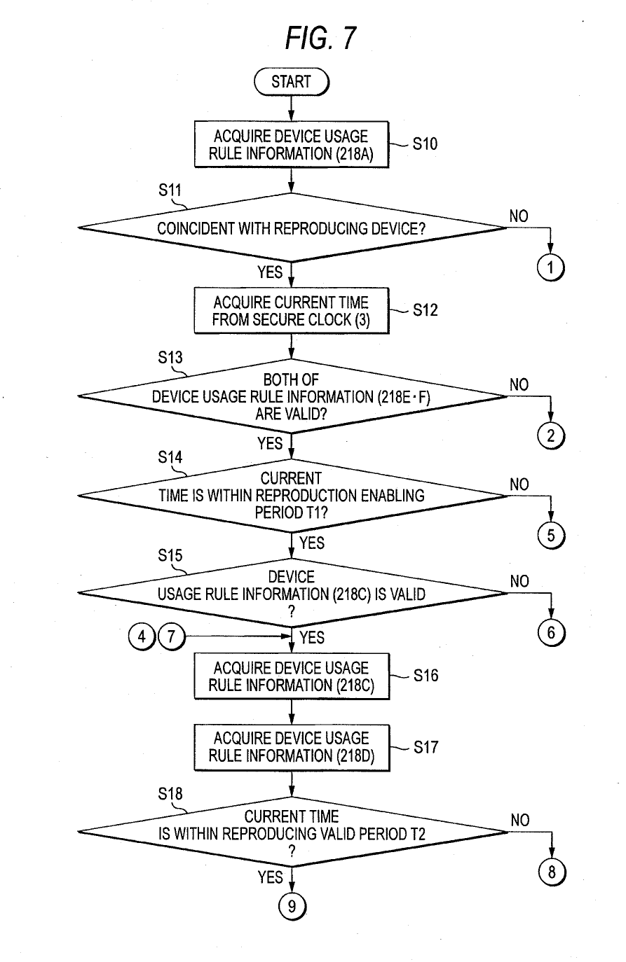

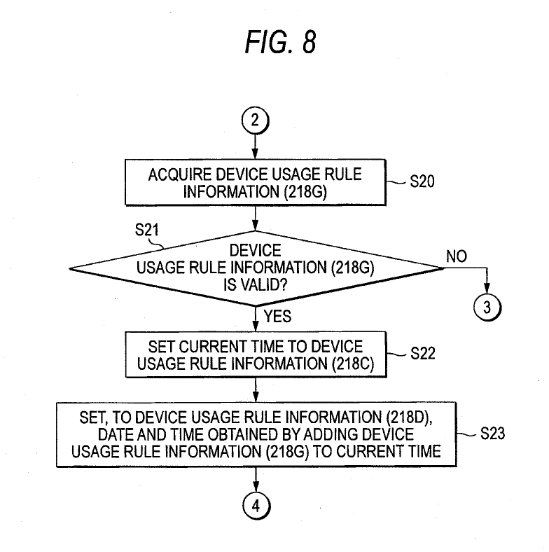

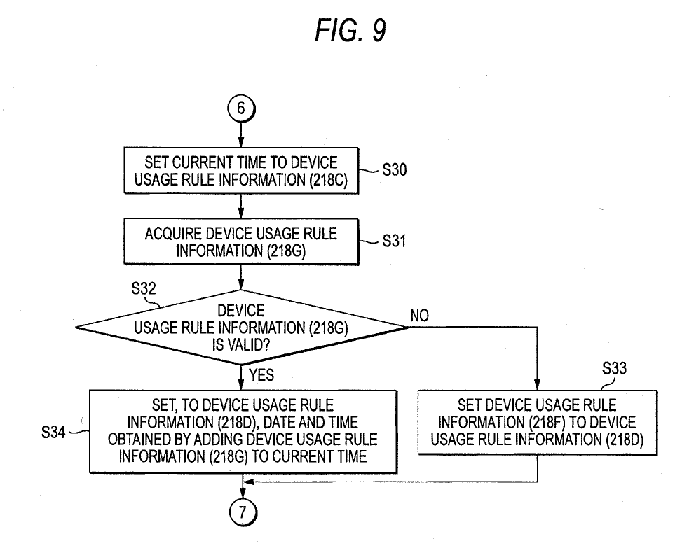

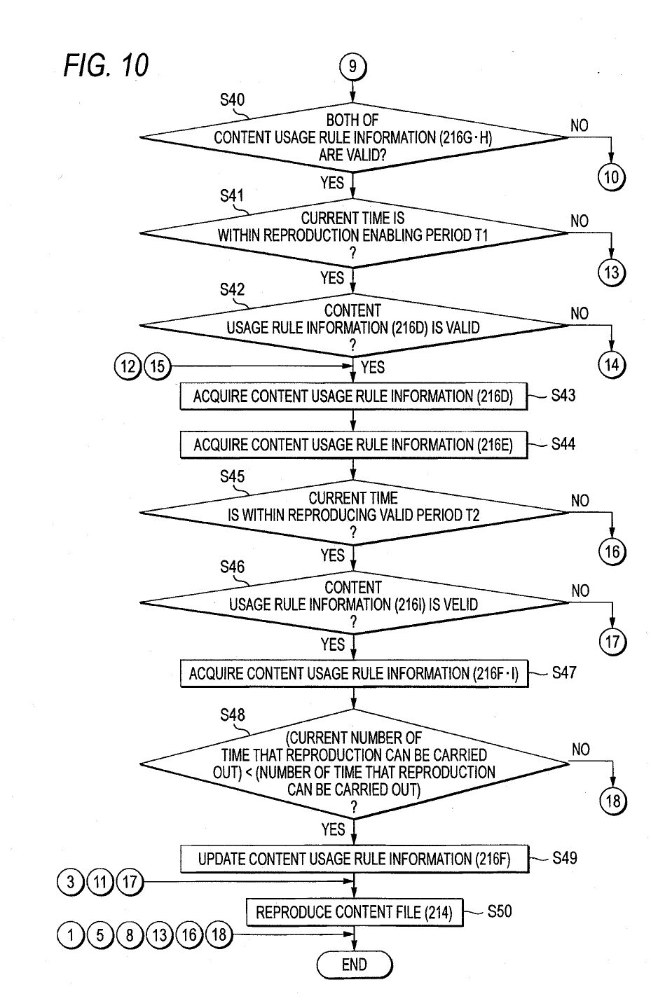

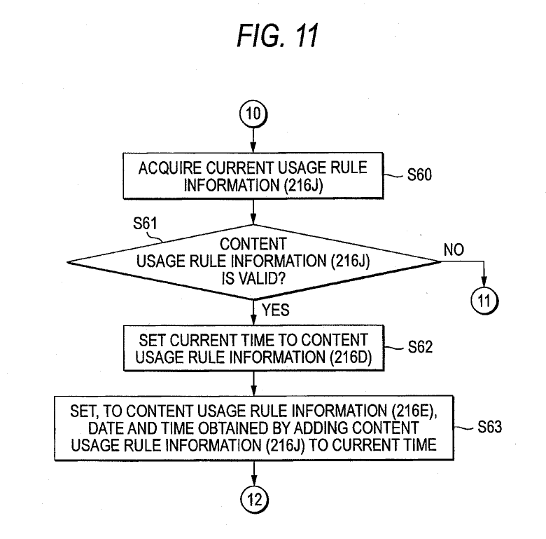

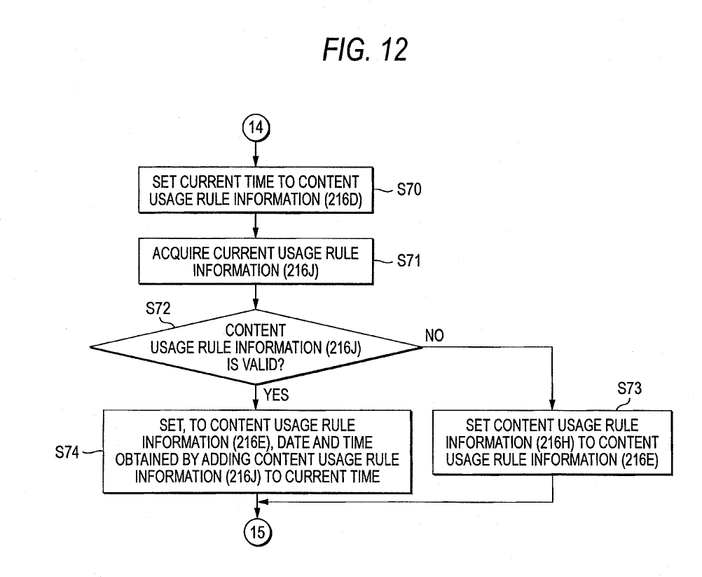

With reference to FIGS. 7 to 12, next, description will be given to an operation of the reproducing device 101 in the case in which the content file 214 stored in the SD memory card 103 is reproduced. FIG. 7 is a flowchart showing a reproducing determination through the Device Usage Rule information 218 of the reproducing device 101 according to the embodiment of the invention. FIG. 8 is a flowchart showing processing for setting the Device Usage Rule information 218 of the reproducing device according to the embodiment of the invention. FIG. 9 is a flowchart showing processing to be carried out in an initial reproduction through the Device Usage Rule information 218 of the reproducing device 101 according to the embodiment of the invention. FIG. 10 is a flowchart showing the reproducing determination through the Content Usage Rule information 216 of the reproducing device 101 according to the embodiment of the invention. FIG. 11 is a flowchart showing processing for setting the Content Usage Rule information 216 of the reproducing device according to the embodiment of the invention. FIG. 12 is a flowchart showing processing to be carried out in an initial reproduction through the Content Usage Rule information 216 of the reproducing device 101 according to the embodiment of the invention.

First of all, description will be given with reference to FIG. 7. The controller 1 acquires the Device Usage Rule information 218A from the SD memory card 103 (Step S10). Next, it is determined whether identification information of a reproducing device which is being operated is coincident with the reproducing device identification information 218A stored in the Device Usage Rule information 218A (Step S11). As a result, if it is determined that they are not coincident with each other (No in the Step S11), the procedure is ended. In other words, only a reproducing device registered in the Device Usage Rule information 218 can carry out a reproduction. On the other hand, if it is determined that they are coincident with each other (Yes in the Step S11), the controller 1 then acquires a current time from the secure clock 3 (Step S12).

Subsequently, the controller 1 determines whether both of the flags of the Device Usage Rule information 218E and the Device Usage Rule information 218F are valid or not (Step S13). As a result, if it is determined that they are not valid (No in the Step S13), the processing proceeds to Step S20 which will be described below. In other words, if setting related to the reproduction enabling period T1 is not valid, the starting date and time and the ending date and time of the reproducing valid period T2 are set. On the other hand, if it is determined that they are valid (Yes in the Step S13), the controller 1 then determines whether the current time is within the reproduction enabling period T1 or not (Step S14). The reproduction enabling period T1 indicates a period between the starting date and time of the reproduction enabling period T1 which is set based on the Device Usage Rule information 218E and the ending date and time of the reproduction enabling period T1 which is set based on the Device Usage Rule information 218F.

As a result, if it is determined that the current time is not within the reproduction enabling period T1 (No in the Step S14), the procedure is ended. In other words, if the current time is not within the reproduction enabling period T1, it is impossible to operate the reproducing device 101 and to reproduce the content. On the other hand, if it is determined that the current time is within the reproduction enabling period T1 (Yes in the Step S14), the controller 1 then determines whether the flag of the Device Usage Rule information 218C is valid or not (Step S15).

As a result, if it is determined that the Device Usage Rule information 218C is not valid (No in the Step S15), the processing proceeds to Step S30 which will be described below. On the other hand, if it is determined that the Device Usage Rule information 218C is valid (Yes in the Step S15), the controller 1 then acquires the Device Usage Rule information 218C (Step S16). Subsequently, the controller 1 acquires the Device Usage Rule information 218D (Step S17).

Thereafter, the controller 1 determines whether the current time is within the reproducing valid period T2 or not (Step S18). The reproducing valid period T2 indicates a period between the starting date and time of the reproducing valid period T2 which is set based on the Device Usage Rule information 218C and the ending date and time of the reproducing valid period T2 which is set based on the Device Usage Rule information 218D.

As a result, if it is determined that the current time is not within the reproducing valid period T2 (No in the Step S18), the procedure is ended. In other words, if the current time is not within the reproducing valid period T2, the content is not reproduced. On the other hand, if it is determined that the current time is within the reproducing valid period T2 (Yes in the Step S18), the processing proceeds to Step S40 which will be described below.

Next, processing for setting the Device Usage Rule information 218 will be described with reference to FIG. 8.

First of all, the controller 1 acquires the Device Usage Rule information 218G (Step S20). Next, it is determined whether the Device Usage Rule information 218G is valid or not (Step S21). As a result, if it is determined that the Device Usage Rule information 218G is not valid (No in the Step S21), the processing proceeds to Step S50 which will be described below. On the other hand, if it is determined that the Device Usage Rule information 218G is valid (Yes in the Step S21), the controller 1 then sets the current time to the Device Usage Rule information 218C (Step S22). Thereafter, the number of days of the reproducing valid period T2 of the Device Usage Rule information 218G is added to the current time and a value thus obtained is set to the Device Usage Rule information 218D (Step S23).

By the Steps S20 to S23, there are completely set the Device Usage Rule information 218C and the Device Usage Rule information 218D in the case in which the reproduction enabling period T1 is not set. The Step S23 proceeds to the Step S16.

Next, processing for updating the Device Usage Rule information 218 in an initial reproduction will be described with reference to FIG. 9.

First of all, if it is determined that the Device Usage Rule information 218C is not valid (No in the Step S15), the current time is set to the Device Usage Rule information 218C (Step S30). In other words, a current time that the reproduction is executed is set to be the starting date and time of the reproducing valid period T2.

Then, the controller 1 acquires the Device Usage Rule information 218G (Step S31). Thereafter, the controller 1 determines whether the flag of the Device Usage Rule information 218G is valid or not (Step S32). As a result, if it is determined that the flag is not valid (No in the Step S32), the Device Usage Rule information 218F is set to be the Device Usage Rule information 218D (Step S33). In other words, if the reproducing valid period is not set, it is set to an identical date and time to the ending date and time of the reproduction enabling period T1.

On the other hand, if it is determined that the flag is valid (Yes in the Step S32), the controller 1 subsequently sets, to the Device Usage Rule information 218D, a date and time obtained by adding the Device Usage Rule information 218G to the current time (Step S34). In other words, a date and time obtained by adding the number of days of the reproducing valid period T2 to the current time is set to be the ending date and time of the reproducing valid period T2.

By the Steps S30 to S34, there is completely set the Device Usage Rule information 218C and the Device Usage Rule information 218D in the initial reproduction. The Steps S33 and S34 proceed to the Step S16.

By the procedure shown in the flowcharts of FIGS. 7 to 9, the reproducing determination for the Device Usage Rule information 218 is ended. Next, a reproducing determination for the Content Usage Rule information 216 will be described with reference to FIGS. 10 to 12.

First of all, the controller 1 determines whether both of the flags of the Content Usage Rule information 216G and the Content Usage Rule information 216H are valid or not (Step S40). As a result, if it is determined that they are not valid (No in the Step S40), the processing proceeds to Step S60 which will be described below. In other words, if setting related to the reproduction enabling period T1 is not valid, the starting date and time and the ending date and time of the reproducing valid period T2 are set. On the other hand, if it is determined that they are valid (Yes in the Step S40), the controller 1 then determines whether the current time is within the reproduction enabling period T1 or not (Step S41). The reproduction enabling period T1 indicates a period from the starting date and time of the reproduction enabling period T1 which is set based on the Content Usage Rule information 216G to the ending date and time of the reproduction enabling period T1 which is set based on the Content Usage Rule information 216H.

As a result, if it is determined that the current time is not within the reproduction enabling period T1 (No in the Step S41), the procedure is ended. In other words, if the current time is not within the reproduction enabling period T1, it is impossible to operate the reproducing device 101 and to reproduce the content. On the other hand, if it is determined that the current time is within the reproduction enabling period T1 (Yes in the Step S41), the controller 1 then determines whether the flag of the Content Usage Rule information 216D is valid or not (Step S42).

As a result, if it is determined that the Content Usage Rule information 216D is not valid (No in the Step S42), the processing proceeds to Step S70 which will be described below. On the other hand, if it is determined that the Content Usage Rule information 216D is valid (Yes in the Step S42), the controller 1 then acquires the Content Usage Rule information 216D (Step S43). Subsequently, the controller 1 acquires the Content Usage Rule information 216E (Step S44).

Thereafter, the controller 1 determines whether the current time is within the reproducing valid period T2 or not (Step S45). The reproducing valid period T2 indicates a period from the starting date and time of the reproducing valid period T2 which is set based on the Content Usage Rule information 216D to the ending date and time of the reproducing valid period T2 which is set based on the Content Usage Rule information 216E.

As a result, if it is determined that the current time is not within the reproducing valid period T2 (No in the Step S45), the procedure is ended. In other words, if the current time is not within the reproducing valid period T2, the content is not reproduced. On the other hand, if it is determined that the current time is within the reproducing valid period T2 (Yes in the Step S45), the controller 1 then determines whether the Content Usage Rule information 216I is valid or not (Step S46). In other words, it is determined whether the number of times that the content can be reproduced is set or not.

As a result, if it is determined that the Content Usage Rule information 216I is not valid (No in the Step S46), the processing proceeds to the Step S50 which will be described below. In other words, the case in which the number of times that the content can be reproduced is not set indicates the case in which the reproduction can be carried out at an infinite number of times. On the other hand, if it is determined that the Content Usage Rule information 216I is valid (Yes in the Step S46), the controller 1 then acquires the Content Usage Rule information 216F and the Content Usage Rule information 216I (Step S47).

Next, the controller 1 determines whether a current number of times that the content is reproduced is smaller than the number of times that the content can be reproduced or not (Step S48). As a result, if it is determined that the current number of times that the content is reproduced is not smaller than the number of times that the content can be reproduced (No in the Step S48), the procedure is ended. On the other hand, if it is determined that the current number of times that the content is reproduced is smaller than the number of times that the content can be reproduced (Yes in the Step S48), the controller 1 then updates the Content Usage Rule information 216F (Step S49). In other words, one is added to the current number of times that the reproduction is carried out.

Subsequently, the controller 1 executes the reproduction of the content file 214 (Step S50).

More specifically, the content file 214 and the key information 216B which are stored in the SD memory card 103 are read through the removable media I/F 2 and are transmitted to the decoder 6. The content decoded by the decoder 6 is demultiplexed into every type of data through the TS-DEMUX 7, and is subjected to processing in each module and is then output. When the reproduction is ended, the reproduction determining procedure is ended.

In the case in which the reproducing device 101 does not have a reproducing function corresponding to the content file 214, software for implementing a corresponding reproducing function is downloaded through a network. Alternatively, an update is carried out through media and an installation into the reproducing device 101 is thus performed. Moreover, it is also possible to prestore content reproducing software in the SD memory card 103 and to properly carry out an installation in the reproduction of the content or to directly activate the SD memory card 103.

In the embodiment, it is impossible to execute the corresponding reproducing function to the acquired content file 214 as described above after the reproducing valid period T2 which is stored in the Device Usage Rule information 218. In the case in which the reproduction is executed after the reproducing valid period T2 through the reproducing device 101 having the corresponding reproducing function to the content file 214 originally, the reproduction of the content file 214 stored in the SD memory card 103 is not executed.

Next, processing for setting the Content Usage Rule information 216 will be described with reference to FIG. 11.

First of all, if it is determined that the flags of the Content Usage Rule information 216G and the Content Usage Rule information 216H are not valid (No in the Step S40), the controller 1 acquires the Content Usage Rule information 216J (Step S60). Next, it is determined whether the Content Usage Rule information 216J is valid or not (Step S61). As a result, if it is determined that the Content Usage Rule information 216J is not valid (No in the Step S61), the processing proceeds to the Step S50. On the other hand, if it is determined that the Content Usage Rule information 216J is valid (Yes in the Step S61), the controller 1 then sets the current time to the Content Usage Rule information 216D (Step S62). Next, the number of days of the reproducing valid period T2 of the Content Usage Rule information 216J is added to the current time and a value thus obtained is set to the Content Usage Rule information 216E (Step S63). The Step S63 proceeds to the Step S43.

By the Steps S60 to S63, there are completely set the Content Usage Rule information 216D and the Content Usage Rule information 216E in the case in which the reproduction enabling period T1 is not set.

Next, processing for updating the Content Usage Rule information 216 in an initial reproduction will be described with reference to FIG. 12.

First of all, if it is determined that the Content Usage Rule information 216D is not valid (No in the Step S42), the current time is set to the Content Usage Rule information 216D (Step S70). In other words, a current time that the reproduction is executed is set to be the starting date and time of the reproducing valid period T2.

Then, the controller 1 acquires the Content Usage Rule information 216J (Step S71). Thereafter, the controller 1 determines whether the flag of the Content Usage Rule information 216J is valid or not (Step S72). As a result, if it is determined that the flag is not valid (No in the Step S72), the Content Usage Rule information 216H is set to be the Content Usage Rule information 216E (Step S73). In other words, if the reproducing valid period is not set, it is set to an identical date and time to the ending date and time of the reproduction enabling period T1.

On the other hand, if it is determined that the flag is valid (Yes in the Step S72), the controller 1 subsequently sets, to the Content Usage Rule information 216E, a date and time obtained by adding the Content Usage Rule information 216J to the current time (Step S74). In other words, a date and time obtained by adding the number of days of the reproducing valid period T2 to the current time is set to be the ending date and time of the reproducing valid period T2.

By the Steps S70 to S74, there is completely set the Content Usage Rule information 216D and the Content Usage Rule information 216E in the initial reproduction. The Steps S73 and S74 proceed to the Step S43.

Although the Device Usage Rule information 218 is determined and then the Content Usage Rule information 216 is determined in the reproduction determining procedure, the invention is not restricted thereto. In other words, it is also possible to determine the Device Usage Rule information 218 after determining the Content Usage Rule information 216.

As described above, according to the embodiment of the invention, the content is reproduced by referring to the utilization permitting information of the content and the utilization permitting information of the reproducing device which are copyrighted by a removable storage medium. Accordingly, the content is reproduced only in the case in which both of the utilization permitting information are satisfied. More specifically, it is possible to control the utilization of the content reproducing function of the reproducing device itself by using rewritable recording media having a copyrighting function.

The invention is not exactly restricted to the embodiment but the components can be changed and made concrete without departing from the scope thereof in an implementing stage. By a proper combination of the components disclosed in the embodiment, moreover, it is possible to form various inventions. For example, it is also possible to delete some of all the components described in the embodiment. Furthermore, it is also possible to properly combine components according to different embodiments.

What is claimed is:

1. A reproducing device comprising:
a media reader configured to read, from a detachable storage medium, at least one of content data, content permissions, and reproducing device permissions;
a permission verifier configured to determine whether the content permissions and the reproducing device permissions are satisfied; and
a reproduction controller configured to reproduce the content data when the content permissions and the reproducing device permissions are determined to be satisfied by the permission verifier.

2. The reproducing device of claim 1, further comprising a time receiver configured to receive time information, wherein:
the permission verifier is further configured to determine whether the content permissions are satisfied based upon whether a reproduction starting time obtained from the time information is within one or more permitted reproduction periods in a permitted period set, said permitted period set comprising at least a first permitted reproduction period defined in the reproducing device permissions.

3. The reproducing device of claim 2, wherein:
the permission verifier is configured to determine whether the content permissions are satisfied based upon whether a reproduction tally obtained from the content permissions is less than a reproduction limit defined in the content permissions; and
the permitted period set further comprises a second permitted reproduction period defined in the content permissions.

4. The reproducing device of claim 3, wherein the permitted period set further comprises:
a third permitted reproduction period obtained in part by adding a first number of days defined in the reproducing device permissions to the reproduction starting time; and
a fourth permitted reproduction period obtained in part by adding a second number of days defined in the content permissions to the reproduction starting time.

5. The reproducing device of claim 3, wherein:
the permission verifier is further configured to set, as a third permitted reproduction period, a period from the reproduction starting time to an ending date and time of the first reproduction enabling period, and
the permission verifier is further configured to set, as a forth permitted reproduction period, a period from the reproduction starting time to an ending date and time of the second reproduction enabling period.

6. A detachable storage medium comprising:
content data capable of reproduction by a reproducing device;
content permissions comprising at least one of a reproduction limit specifying the number of times that the content data may be reproduced and a first permitted reproduction period of the content data; and
reproducing device permissions comprising at least one of identification information identifying at least one reproducing device capable of reproducing the content data and a second reproduction enabling period during which the content data may be reproduced by the reproducing device.
